(19) United States
(12) Patent Application Publication
(10) Pub. No.: US 2017/0359642 A1
(43) Pub. Date: Dec. 14, 2017

(54) CASE FOR MOBILE TERMINAL

(71) Applicant: DIASONIC TECHNOLOGY CO., LTD., Anyang-Si (KR)

(72) Inventor: Soo Whoan CHO, Anyang-Si (KR)

(21) Appl. No.: 15/618,118

(22) Filed: Jun. 8, 2017

(30) Foreign Application Priority Data
Jun. 8, 2016 (KR) 20-2016-0003113

(51) Int. Cl. H04R 1/02; G06F 1/18; H04B 1/3888; H04M 1/02

(52) U.S. Cl. CPC H04R 1/028; H04M 1/026; H04M 1/0254; G06F 1/189; H04B 1/3888; H04R 2201/028; H04R 2499/11

(57) ABSTRACT

A case for mobile terminal has a case having a space portion for accommodating the mobile terminal thereinside and having a coupling face formed on at least a portion thereof; and a sound source playing module being communicationally connected with the mobile terminal and for playing sound sources stored in the mobile terminal. The sound source playing module is detachably coupled on the coupling face.

### CROSS-REFERENCE TO RELATED APPLICATION

This application claims priority to and the benefit of Korean Utility Model Application No. 20-2016-0003113 filed in the Korean Intellectual Property Office on Jun. 8, 2016, the entire contents of which are incorporated herein by reference.

### TECHNICAL FIELD

The present invention relates to a case for mobile terminal, and more particularly, to a case for mobile terminal accommodating a mobile terminal thereinside.

### BACKGROUND ART

By the development of information communication field of today, information and communication circumstance shows rapid change. Among such changes, mobile terminals in mobile communication field are used in abundance as to be thought as requisites in contemporary society. With such an expansion of the base of mobile communication field, variety of functions are added to variety of mobile terminals, by which, currently, internet became available as well as voice communication, message transmission and data storage and so on.

On the other hand, storage and existence form of information moves from analog to digital recently, and, particularly by the development of MPEG technology of compression standard of video data, the size of digital image gets smaller gradually. Accordingly, more data become to be stored in the memory used at the mobile terminal, and not only image data but also voice data are getting to be digitized.

Here, a sound source of MP3 (MPEG Audio layer-3) type is receiving attention by which music can be enjoyed with digital data of smaller size in which an analog sound source signal is converted to digital sound source signal and the MPEG compression technology is applied for audio compression. And as the propagation of sound sources of MP3 type is spread, MP3 players equipped with storage means of MP3 sound sources and playing means for playing the MP3 sound sources, or mobile terminals loaded with the same became to be widely spread with which MP3 sound sources can be played during movement. And, variety storage format types of sound sources like WAV, FLAC, WMA, and so on besides MP3 are used according to taste of users.

Digital sound sources like MP3 sound source have low bit rate and low sampling frequency value to decrease the size of data, by which digital sound sources like MP3 sound source have declined sound quality. Demand from users for listening sound source of higher quality from MP3 digital sound source having such a low bit rate and sampling frequency value is gradually increasing. Thus, other sound source playing devices are being developed actively for playing digital sound sources with conversion to high quality sound sources.

However, such a sound source playing device for conversing and playing digital sound source is designed as a separate device connected to a mobile terminal, whose transportability falls notably in view of property of mobile terminal whose main usage is enjoying music during movement. And in case that mobile terminal and sound source playing device are configured to be coupled in integrity for enhanced transportability, sound source playing devices corresponding to each of variety types of mobile terminals should be manufactured separately, which incurs problem of markedly declined compatibility and economy.

### RELATED ART DOCUMENT

(Patent document 0001) KR 10-0695368 B1

### DISCLOSURE

### Technical Problem

The present utility model is to provide a case for mobile terminal including a sound source playing module for playing sound source stored in the mobile terminal.

And the present utility model is to provide a case for mobile terminal capable of detachably coupling the sound source playing module regardless of type of the mobile terminal.

### Technical Solution

A case for mobile terminal according to an embodiment of the present utility model comprise a case having a space portion for accommodating the mobile terminal thereinside and having a coupling face formed on at least a portion thereof; and a sound source playing module being communicationally connected with the mobile terminal and for playing sound sources stored in the mobile terminal, wherein the sound source playing module is detachably coupled on the coupling face.

The sound source playing module may further comprise an input terminal portion for being input with sound sources stored in the mobile terminal; a controller portion for conversion of digital signals of sound sources input from the input terminal portion to pulse code modulation (PCM) signals; a digital analog conversion portion for conversion of the pulse code modulation signals to analog signals; and an output terminal portion for output of the analog signals to outside.

The sound source playing module may further comprise an electric power supply portion for supply of electric power to the controller portion and the digital analog conversion portion, wherein the electric power supply portion may selectively supply electric power to the mobile terminal.

The electric power supply portion may supply electric power to the mobile terminal in a wireless way.

The coupling face may be formed with depression from outer surface of the case.

The case for mobile terminal may further comprise fixing bodies for fixing the sound source playing module to the case.

At least one coupling holes may be formed with penetration on the coupling face; and the fixing bodies may be screw coupled through the coupling holes from inside of the case.

The coupling holes may be formed with steps so as to have decreasing diameters from inside of the case; and the fixing bodies may be coupled so as for end portions thereof to be positioned inside of the coupling holes.

At least one hanging grooves may be formed on the coupling face; and at least one hanging projections for engaging to the hanging grooves may be formed on the sound source playing module.

The case for mobile terminal may further comprise a joint member electrically connecting a recharging terminal portion of the mobile terminal and the input terminal portion.

The joint member may be formed with being bent so as for both end portions thereof to be inserted and fixed to the input terminal portion and the recharging terminal portion.

The joint member may be formed of hard material.

The sound source playing module may be coupled to the case so as for the input terminal portion to be arranged in a direction corresponding to the recharging terminal portion; and the joint member may be formed in a shape of ‘U’ character comprising extending portions each of which extending toward the input terminal portion and the recharging terminal portion, and connection portions connecting each of the extending portions.

The connection portion may be formed stretchably.

The connection portions may comprise a first connection bar and a second connection bar which being slid and coupled each other.

The joint member may further comprise an elasticity member providing attraction between the first connection bar and the second connection bar.

### Advantageous Effects

According to a case for mobile terminal according to an embodiment of the present utility model, sound quality of sound sources played can be improved by output with conversion from digital signals of sound sources stored in the mobile terminal to high quality analog signals.

And the case for mobile terminal is configured to couple the sound source playing module changing digital signals of sound source onto the case accommodating the mobile terminal by which the transportability can be improved, and an electric power supply portion selectively supplying electric power to the mobile terminal in a wired or wireless way is provided on the sound source playing module by which the case can be utilized as an auxiliary battery for the mobile terminal.

Besides, the sound source playing module is detachably coupled to the cases manufactured for the mobile terminals respectively, by which the case becomes to be able to be compatible to variety kinds of mobile terminals by only exchanging cases accommodating the mobile terminal.

### DESCRIPTION OF DRAWINGS

FIG. 1 is a perspective view showing an overall image of a case for mobile terminal according to an embodiment of the present utility model.

FIG. 2 is a perspective view showing the case for mobile terminal of FIG. 1 from another direction.

FIG. 3 is a block diagram showing a rough configuration of a sound source playing module according to an embodiment of the present utility model.

FIG. 4 is a separative perspective view showing a separated image of the case for mobile terminal according to an embodiment of the present utility model.

FIG. 5 is a separative perspective view showing the case for mobile terminal of FIG. 4 from another direction.

FIG. 6 is a perspective view showing an image of a joint member according to an embodiment of the present utility model.

### BEST MODE

A case for mobile terminal according to the present utility model provides technical features capable of outputting high quality sound by conversion of sound sources stored in mobile terminal. And the case for mobile terminal according to the present utility model provides technical features for securing transportability of sound source play device for playing sound of high quality and capable of applied to all of variety kinds of mobile terminals with compatibility.

Hereinafter, embodiments of the present utility model will be described in detail with reference to attached drawings. However, the present utility model is not to be limited to the embodiments disclosed below, but may be implemented in variety of different forms, and the embodiments of the present utility model is provided only to make complete disclosure of the present utility model and to make the scope of the utility model be known completely to ordinary skilled persons. The same codes in the drawings denotes the same elements.

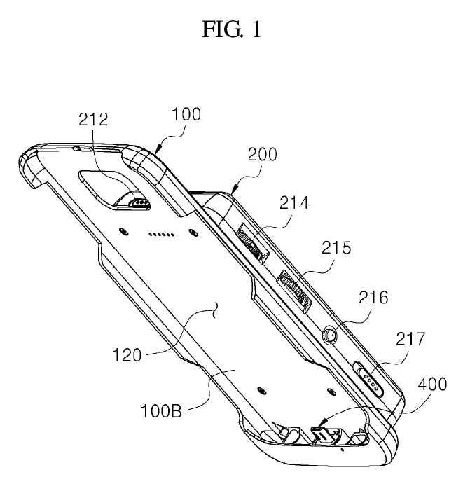

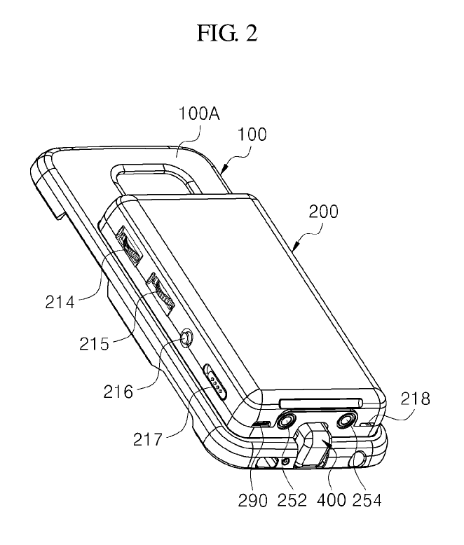

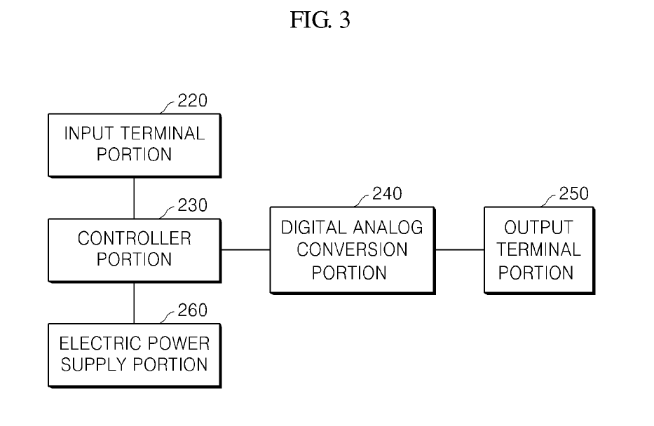

FIG. 1 is a perspective view showing an overall image of a case for mobile terminal according to an embodiment of the present utility model and FIG. 2 is a perspective view showing the case for mobile terminal of FIG. 1 from another direction. More specifically, FIG. 1 is a perspective view of the case for mobile terminal according to an embodiment of the present utility model shown from an upper side, and FIG. 2 is a perspective view of the case for mobile terminal according to an embodiment of the present utility model shown from an lower side. And FIG. 3 is a block diagram showing a rough configuration of a sound source playing module according to an embodiment of the present utility model.

Referring to FIG. 1 to FIG. 3, a case for mobile terminal according to an embodiment of the present utility model comprise a case 100 having a space portion 120 for accommodating the mobile terminal (not shown) thereinside and having a coupling face 140 formed on at least a portion thereof; and a sound source playing module 200 being communicationally connected with the mobile terminal and for playing sound sources stored in the mobile terminal, and the sound source playing module 200 is detachably coupled on the coupling face 140.

Here, the term ‘mobile terminal’ is used in a comprehensive meaning including digital equipment such as smart phone, portable telephone equipment, tablet PC, PDA, Web pad and the like.

The case 100 has the space portion 120 for accommodating the mobile terminal thereinside, and in the space portion 120, the mobile terminal is detachably coupled and stuck onto an inner surface 1008. The case 100 may be formed so as for at least a portion of front face thereof to be opened, and on at least a portion of an outer surface of the case 100 (for example, a rear face of the case), the coupling face 140 may be formed. Here, the coupling face 140 means a face on which the sound source playing module 200 may be coupled, and may have a shape corresponding to an end face of the sound source playing module 200 contacting to the case 100. And the case 100 may be formed so as for at least a portion of a lower end thereof to be opened by which a recharging terminal portion (not shown) of the mobile terminal coupled thereinside can be exposed.

Cases of variety of shapes may be, of course, used as the case 100 which can be formed so as for at least one face among an upper face, a lower face and both of side faces to wrap the mobile terminal, can have the space portion 120 for accommodating the mobile terminal thereinside, and the coupling face 140 can be formed on an outer surface 100A.

The sound source playing module 200 is communicatively connected with the mobile terminal coupled to the case 100, and plays sound sources stored in the mobile terminal with conversion. The sound source playing module 200 and the mobile terminal may be communicatively connected in a wired way or a wireless way, and though in the drawings, an embodiment for connecting the sound source playing module 200 to the mobile terminal in a wired way by a joint member 400 is shown, it is of course that a wireless way such as Bluetooth and so on of short distance wireless communication technology may be applied.

The sound source playing module 200 may further comprise an input terminal portion 220 for being input with sound sources stored in the mobile terminal; a controller portion 230 for conversion of digital signals of sound sources input from the input terminal portion 220 to pulse code modulation (PCM) signals; a digital analog conversion portion 240 for conversion of the pulse code modulation signals to analog signals; and an output terminal portion 250 for output of the analog signals to outside.

The input terminal portion 220 is input with digital sound source files having format of WAV, FLAC, WMA, MP3 and so on stored in the mobile terminal. The input terminal portion 220 may include Bluetooth chipsets installed on the sound source playing module 200 in case of connection with the mobile terminal in a wireless way, and may include USB port or Lightening port for electrical connection with the recharging terminal portion of the mobile terminal in case of connection in a wired way.

The controller portion 230 perform conversion of digital signals of digital sound source files input from the input terminal portion 220 to pulse code signals. More particularly, it can perform conversion of digital signals of digital sound source files having format of WAV, FLAC, WMA, MP3 and so on stored in the mobile terminal to pulse code modulation signals of more than 32 bits and more than 384 kHz.

In general, digital sound source files stored in the mobile terminal have sampling frequency of 16 bit 44.1 kHz. The controller portion 230 can improve sound quality by perform conversion of digital signals of digital sound source files having such a low bit and sampling frequency to pulse code modulation signals of more than 32 bit and more than 384 kHz. As for Up-bit and Over sampling for improving sound quality, a number of technologies are known to public, and detailed description for the same will be omitted.

The digital analog conversion portion 240 (DAC: Digital Analog Converter) performs pulse code modulation signals converted by the controller portion 230 to analog signals as described above, and the converted analog signals are output to outside through the output terminal portion 250. The output terminal portion 250 may include a line port 252 or the like for connection with ear phone/head phone port 254, outside amp and the like.

And the sound source playing module 200 may further include an amplification portion (not shown) for amplifying analog signals converted by the digital analog conversion portion 240 to a set gain value. By the amplification portion, the gain values may be set different so that the ear phone/head phone port 254 outputs analog signals of high power while the line port 252 connected with the outside amp or the like outputs analog signals of relatively low power.

And the sound source playing module 200 may further include an electric power supply portion 260 for supplying electric power to the controller portion 230 and the digital analog conversion portion 240, and the electric power supply portion 260 may supply electric power selectively to the mobile terminal.

The electric power supply portion 260 supply electric power to each of elements needing electric power such as the controller portion 230, the digital analog conversion portion 240 and the amplification portion to drive the sound source playing module 200. And the electric power supply portion 260 may supply electric power to the mobile terminal coupled to the case 100, and electric power supply to the mobile terminal may be performed selectively. Here, selective electric power supply to the mobile terminal may be, of course, performed by a control signal of the controller portion 230 or by controlling mechanical electric contact by a recharging switch described later. The electric power supplied to the mobile terminal may be used for driving or recharging of the mobile terminal, and the electric power supply portion 260 may supply electric power through the joint member 400 in case that the mobile terminal and the sound source playing module 200 are connected in a wired way, while may supply electric power in a wireless way such as electromagnetic induction or the like in case that the mobile terminal and the sound source playing module 200 are connected in a wireless way.

And the electric power supply portion 260 may include a lithium-ion battery or the like of rechargeable type, and may be recharged by being applied with electric power from a separate recharging port 290 formed on the sound source playing module 200.

Hereinafter, detailed functions in relation to each switches of the sound source playing module 200 according to an embodiment of the present utility model will be described in detail.

A recharging switch 212 is for selection of electric power supply to the sound source playing module 200 by the electric power supply portion 260 as described above. That is, according to input of the recharging switch 212, whether the electric power supply portion 260 supplies electric power for driving the sound source playing module 200 only or the electric power supply portion 260 supplies electric power not only to the sound source playing module 200 but also to the mobile terminal is selected. According to the recharging switch 212, the controller portion 230 delivers a control signal, by which electric power to the mobile terminal can be selectively supplied.

And it may be provided with additional indicating means such as LED 213 for the user to identify the power amount and normal operation of the electric power supply portion 260. Such an identification of power amount and normal operation may be controlled by an auxiliary controller portion (not shown) for function expansion of the controller portion 230. And the auxiliary controller portion, of course, may perform a function of automatic shutting off of electric power supply to the sound source playing module 200 in case that there is no selection operation at a play switch 214 described below during a predetermined period and during no play of sound sources.

The play switch 214 may select play functions of the sound source playing module 200, that is play and pause of sound source, play of previous sound source, and play of next sound source, and the like. And a volume switch 215 may control volume of played sound source, and a sound field switch 216 may be further provided to change sound field effect of played sound source. The sound field effect here means effects set according to kinds of sound sources such as jazz, classic, pop, and so on.

An electric power switch 217 selects ON and OFF of the sound source playing module 200. And the electric power switch may be additionally provided with LOCK function for preventing from malfunction of other switches as well as ON and OFF function.

A mode selection switch 218 may enable differentiating gain values of output analog signals. That is, by setting different gain values of output analog signals according to the mode selection switch and controlling so as for the output analog signals from, for example, the ear phone/head phone port 254 to be amplified to analog signals of high power of low power, regardless of kinds of ear phone or head phone and the like connected to the ear phone/head phone port 254, sound source of each optimized sound quality can be listened.

An operating system selection switch 219 enables selecting operating system (OS) of the mobile terminal according to kind of the mobile terminal installed to the case 100. For example, the operating system selection switch 219 may be configured to be able to select IOS and Android, by which the sound source playing module 200 can be set to be compatible to all the operating systems of the mobile terminals installed on the case 100. Here, the operating system selection switch 219 may be installed on the sound source playing module 200 on one face facing to the coupling face 140 to prevent from being changed to wrong operating system during operation of the sound source playing module 200 once the operating system is selected according to kind of the mobile terminal.

The sound source playing module 200 provided with functions as described above is detachably coupled onto the coupling face 140 of the case 100.

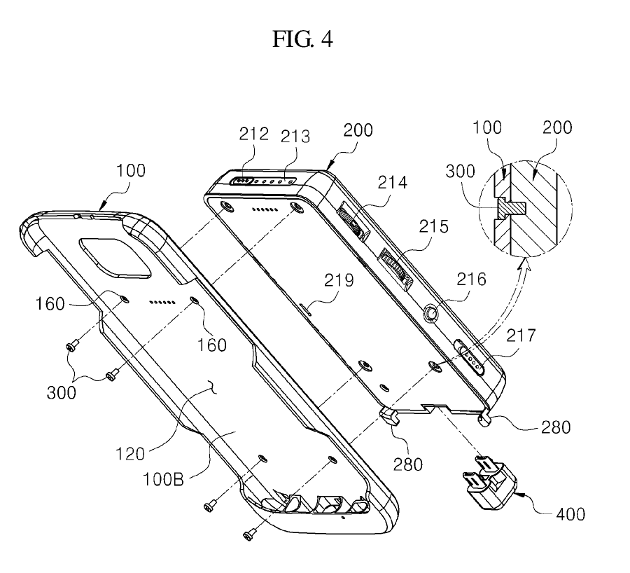

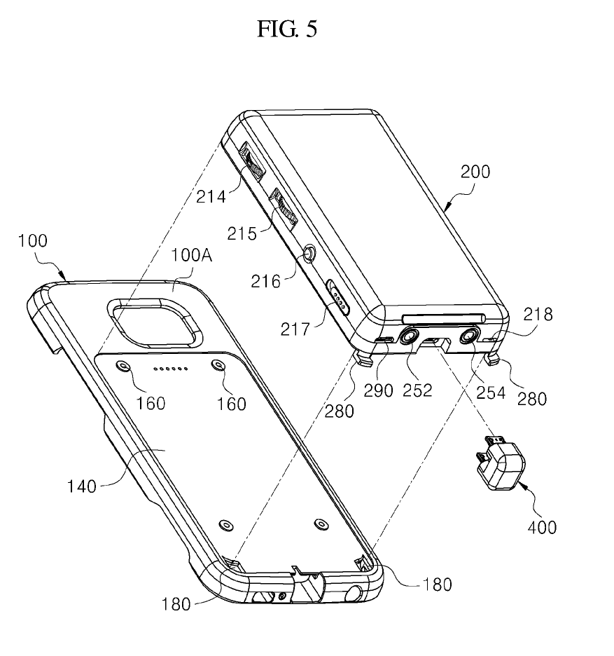

Hereinafter, an image of detachable coupling of the case 100 and the sound source playing module 200 of the case for mobile terminal according to an embodiment of the present utility model will be described in detail with reference to FIG. 4 and FIG. 5.

FIG. 4 is a separative perspective view showing a separated image of the case for mobile terminal according to an embodiment of the present utility model, and FIG. 5 is a separative perspective view showing the case for mobile terminal of FIG. 4 from another direction. That is, FIG. 4 is a separative perspective view of a separated image of the case for mobile terminal according to an embodiment of the present utility model shown from an upper side, and FIG. 5 is a separative perspective view of a separated image of the case for mobile terminal according to an embodiment of the present utility model shown from a lower side.

The sound source playing module 200 is contacted and coupled to the coupling face 140 formed on at least a portion of rear face of the case 100 with one end face thereof. And the coupling face 140 formed on the case 100 is depressed and formed in a predetermined depth from outer surface of the case 100, by which one end portion of the sound source playing module 200 may be inserted and fixed therein.

And the case for mobile terminal according to an embodiment of the present utility model may further include a fixing body 300 for firmly fixing the sound source playing module 200 on the case 100. Here, the fixing body 300 may be a magnetic body or a metallic body each installed on the case 100 or the sound source playing module 200, while, to fix the sound source playing module 200 on the case 100 more firmly, the fixing body 300 may include screws. In case that the sound source playing module 200 is coupled onto the case 100 with such screws, for screw coupling of the fixing body 300, at least one coupling holes 160 may be penetrated and formed on the coupling face 140 provided on the case 100, by which the fixing body 300 can be screw coupled from inner surface of the case 100 through the coupling hole 160 onto the sound source playing module 200.

In case that the sound source playing module 200 is screw coupled by the fixing body 300, to prevent the mobile terminal accommodated inside of the case 100 and contacted to inner surface from contacting to the fixing body 300, the coupling hole 160 may be formed to be stepped to have a decreasing diameter from inside of the case 100. In case that the coupling hole 160 is formed to be stepped to have such a decreasing diameter from inside of the case 100, end portion of the fixing body 300 may be coupled to the sound source playing module 200 so as to be positioned inside of the coupling hole 160, by which risk of outbreak of scratch by contact with the mobile terminal can be minimized.

For more rigid coupling of the sound source playing module 200 and the case 100, at least one hanging groove 180 may be formed on the coupling face 140 of the case 100, and at least one hanging projection 280 engaging to the hanging groove 180 may be formed on the sound source playing module 200. Here, the hanging groove 180 may be formed to extend toward outer direction from the coupling face 140 of the case 100, and the hanging projection 280 may be formed to bend for engagement to the hanging groove 180. In case that the hanging groove 180 is formed on the coupling face 140 of the case 100, to prevent the hanging projection 280 engaged to the hanging groove 180 from being protruded to inner surface of the case 100 to generate interference with the mobile terminal, the hanging groove 180, of course, may be formed with depression between outer surface and inner surface of the case 100.

The case for mobile terminal according to an embodiment of the present utility model may further include the joint member 400 electrically connecting the recharging terminal portion of the mobile terminal and the input terminal portion 220. The joint member 400 may be a soft cable on both ends of which USB terminal or lightening terminal is formed, while to provide additional coupling force to the case 100 in which the mobile terminal is accommodated and the sound source playing module 200, it may be formed to be bent for both end portions thereof to be inserted and fixed in the recharging terminal portion of the mobile terminal and the input terminal portion 220 of the sound source playing module 200, respectively, and in such a case, the joint member 400 may be formed of hard material. More particularly, housing of the joint member 400 may be formed of plastic material or the like, and, of course, USB terminal or lightening terminal is formed on both ends of the joint member 400, and cable electrically connecting both terminals may be provided inside of the housing.

The joint member 400 may be formed in a shape of ‘U’ character provided with extending portions 410 and 420 each extending toward the input terminal portion 220 [symbol] the recharging terminal portion, and a connection portion 430 connecting the extending portions 410 and 420 each other. In case that the joint member 400 is formed in such a shape of ‘U’ character, the input terminal portion 220 of the sound source playing module 200 may be arranged in a direction corresponding to the recharging terminal portion of the mobile terminal, that is, in a direction in which the extending portions 410 and 420 of both sides of the joint member 400 of ‘U’ character shape are inserted in the input terminal portion 220 and the recharging terminal portion respectively. In the drawings, an opened region of lower end central portion of the case 100 is corresponding to a region in which the recharging terminal portion such as recharging port and the like is positioned in case that the mobile terminal is coupled, and a lower end central portion of the sound source playing module 200 (which is between the ear phone/head phone port 254 and the line port 252) is corresponding to a region in which the input terminal portion 220 such as input port and the like is positioned.

And the connection portion 430 of the joint member 400 may be formed to be able to be stretched. The distance from the coupling face 140 to the input terminal portion 220 of the sound source playing module 200 is fixed, while the distance from coupling face 140 to the recharging terminal portion of the mobile terminal may be changed according to thickness of the mobile terminal or thickness of the case 100. Therefore, the connection portion 430 of the joint member 400 may be formed stretchably to be applicable with compatibility to all the variety of kinds of mobile terminals or the cases 100.

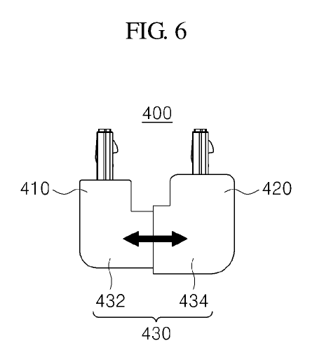

For forming the connection portion 430 of the joint member 400 stretchable, the connection portion 430 may be formed of a soft material against the extending portions 410 and 420 having hard material, while, as shown in FIG. 6, the connection portion 430 may be formed to include a first connection bar 432 and a second connection bar 434 coupled to slide to each other. That is, the first connection bar 432 and the second connection bar 434 forming the connection portion 430 are coupled to slide, and the total length of the connection portion 430 is increased or decreased by slide movement of each connection bars, by which gap between the extending portions 410 and 420 may be adjusted. And the joint member 400 may further include an elasticity member such as spring or the like to maintain gap between the extending portions 410 and 420 by providing attraction between the first connection bar 432 and the second connection bar 434.

As described above, according to the case for mobile terminal according to an embodiment of the present utility model, by outputting digital signals of sound sources stored in the mobile terminal with conversion to high quality analog signals, sound quality of played sound sources can be improved. And the case for mobile terminal is configured to couple such a sound source playing module 200 to the case 100 accommodating the mobile terminal, by which transportability can be improved.

In this case, for strong coupling of the case 100 and the sound source playing module 200, one or more coupling structures described above may be applied such as a structure in which the coupling face 140 is formed with depression from outer surface of the case 100 and one end portion of the sound source playing module 200 is inserted and fixed therein, a structure of screw coupling by the fixing body 300, a structure of engagement by the hanging groove 180 and the hanging projection 280, and so on.

And by inserting and fixing both end portions of the joint member 400 formed with bending into the recharging terminal portion of the mobile terminal and the input terminal portion 220 of the sound source playing module 200 respectively, an additional coupling force, of course, may be provided to the case 100 and the sound source playing module 200.

Therefore, according to the case for mobile terminal according to an embodiment of the present utility model, while maintaining coupling force of the case 100 and the sound source playing module 200, the sound source playing module 200 can be detachably coupled to the cases 100 manufactured in variety for the mobile terminals, by which compatibility to variety of kinds of mobile terminals become available by only exchanging the case 100 accommodating the mobile terminal.

In the above, desirable embodiments of the present utility model are described and depicted using particular terminologies, which are only for clear illustration of the present utility model, and it would be apparent that the embodiments and described terminologies of the present utility model, without parting from the technical idea and scope of claims attached below, may take variety of changes and modifications. Such varied embodiments should not be understood to be separate from the idea and scope of the present utility model, but should be considered to fall in the scope of claims of the present utility model.

### DESCRIPTION OF SYMBOLS

100: case 120: space portion
140: coupling face 160: coupling hole
180: hanging groove 200: sound source playing module
280: hanging projection 300: fixing body
400: joint member 410, 420: extending portion
432: first connection bar 434: second connection bar

1. A case for mobile terminal comprising:
a case having a space portion for accommodating the mobile terminal thereinside and having a coupling face formed on at least a portion thereof; and
a sound source playing module being communicationally connected with the mobile terminal and for playing sound sources stored in the mobile terminal,
wherein the sound source playing module being detachably coupled on the coupling face.

2. The case for mobile terminal according to claim 1, the sound source playing module further comprising:
an input terminal portion for being input with sound sources stored in the mobile terminal;
a controller portion for conversion of digital signals of sound sources input from the input terminal portion to pulse code modulation (PCM) signals;
a digital analog conversion portion for conversion of the pulse code modulation signals to analog signals; and
an output terminal portion for output of the analog signals to outside.

3. The case for mobile terminal according to claim 2, the sound source playing module further comprising an electric power supply portion for supply of electric power to the controller portion and the digital analog conversion portion,
wherein the electric power supply portion selectively supplying electric power to the mobile terminal.

4. The case for mobile terminal according to claim 3, wherein the electric power supply portion is configured to supply electric power to the mobile terminal in a wireless way.

5. The case for mobile terminal according to claim 1, wherein the coupling face is formed with depression from outer surface of the case.

6. The case for mobile terminal according to claim 1, further comprising fixing bodies for fixing the sound source playing module to the case.

7. The case for mobile terminal according to claim 6, wherein at least one coupling holes are formed with penetration on the coupling face; and the fixing bodies are screw coupled through the coupling holes from inside of the case.

8. The case for mobile terminal according to claim 7, wherein the coupling holes are formed with steps so as to have decreasing diameters from inside of the case, and the fixing bodies are coupled so as for end portions thereof to be positioned inside of the coupling holes.

9. The case for mobile terminal according to claim 1, wherein at least one hanging grooves are formed on the coupling face and at least one hanging projections for engaging to the hanging grooves are formed on the sound source playing module.

10. The case for mobile terminal according to claim 2, further comprising a joint member electrically connecting a recharging terminal portion of the mobile terminal and the input terminal portion.

11. The case for mobile terminal according to claim 10, wherein the joint member is formed having a bent portion so as for both end portions thereof to be inserted and fixed to the input terminal portion and the recharging terminal portion.

12. The case for mobile terminal according to claim 10, wherein the joint member is formed of hard material.

13. The case for mobile terminal according to claim 11, wherein the sound source playing module is coupled to the case so as for the input terminal portion to be arranged in a direction corresponding to the recharging terminal portion and the joint member is formed in a shape of ‘U’ character comprising extending portions each of which extending toward the input terminal portion and the recharging terminal portion, and connection portions connecting each of the extending portions.

14. The case for mobile terminal according to claim 13, wherein the connection portion is formed stretchably.

15. The case for mobile terminal according to claim 14, the connection portions comprising a first connection bar and a second connection bar which being slid and coupled each other.

16. The case for mobile terminal according to claim 15, the joint member further comprising an elasticity member providing attraction between the first connection bar and the second connection bar.
